(19) United States
(12) Patent Application Publication
(10) Pub. No.: US 2006/0155686 A1
(43) Pub. Date: Jul. 13, 2006

(54) Facilitating direct access to live controls for features of a system or application via a keyword search

(76) Inventor: John W. Peterson, Menlo Park, CA (US)

Correspondence Address: ADOBE SYSTEMS, INCORPORATED;c/o PARK, VAUGHAN & FLEMING LLP, 2820 FIFTH STREET, DAVIS, CA, 95616-2914, US

(21) Appl. No.: 11/035,624

(22) Filed: Jan. 13, 2005

(51) Int. Cl. G06F 7/00

(52) U.S. Cl. 707/3

(57) ABSTRACT

One embodiment of the present invention provides a system that provides access to features of a system or an application via a query. During operation, the system first obtains a query. Next, the system identifies features of the system or the application which are associated with results of the query. The system then presents live controls for the associated features to a user. This enables the user to activate the live controls to perform associated actions, without having to first navigate to a live control.

### BACKGROUND

1. Field of the Invention

The present invention relates to user interfaces for computer systems. More specifically, the present invention relates to a system that facilitates direct access to live controls for features of a system (or application) via a keyword search.

2. Related Art

Complex systems and applications (such as operating systems and document editors) typically provide a large number of features, which enable a user to perform a wide range of actions. Unfortunately, providing a large number of features makes it difficult to find a specific feature. Even experienced users may find it difficult to keep track of all the features.

Typically, when a user wants to find out how to access a feature, the user has two choices:
(1) the user can manually search through menus and dialogs trying and locate the feature, or
(2) the user can: switch to a “help” system; search the help system; read the results produced by the help system; and switch back to the application.

Note that, if a user is unable to locate a command or a function during a workflow, switching to a help system can be useful. However, in many cases the desired feature is infrequently used, or is incidental to the task at hand. In such situations, switching to a help system is usually distracting. Moreover, the user typically does not want to bother with reading about the feature or tracking it down in the forest of menus, palettes and dialogs. Instead, in these situations, the user typically wants to access the feature as quickly as possible.

Hence, what is needed is a method and an apparatus that facilitates rapidly accessing a feature of a system or an application without the above-described problems.

### SUMMARY

One embodiment of the present invention provides a system that provides access to features of a system or an application via a query. During operation, the system first obtains a query. Next, the system identifies features of the system or the application which are associated with results of the query. The system then presents live controls for the associated features to a user. This enables the user to activate the live controls to perform associated actions, without having to first navigate to a live control.

In a variation on this embodiment, obtaining the query involves receiving a search request for a feature, wherein the search request includes the one or more key words.

In a variation on this embodiment, presenting live controls for the associated features additionally involves presenting menu-path hyperlinks for the associated features to the user.

In a variation on this embodiment, presenting live controls for the associated features also involves providing access to help information for the associated features.

In a variation on this embodiment, if an associated feature is not presently available, the corresponding live control is presented to the user in a manner which indicates that the feature is disabled.

In a variation on this embodiment, presenting a live control for an associated feature involves presenting a preview of the result of an action associated with the live control.

In a variation on this embodiment, a live control for a feature is a user interface element, which can be activated to perform an associated action.

### BRIEF DESCRIPTION OF THE FIGURES

FIG. 1 illustrates a system that facilitates looking up live controls for features of a system (or application) in accordance with an embodiment of the present invention.

FIG. 2 presents a flow chart illustrating the lookup process in accordance with an embodiment of the present invention.

FIG. 3A illustrates an exemplary list of search results including live controls in accordance with an embodiment of the present invention.

FIG. 3B illustrates another exemplary list of search results including a live control in accordance with an embodiment of the present invention.

FIG. 3C illustrates another exemplary list of search results including live controls in accordance with an embodiment of the present invention.

FIG. 3D illustrates yet another list of exemplary search results including live controls in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, magnetic and optical storage devices, such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as a LAN, a WAN, the Internet, or a wireless network. System

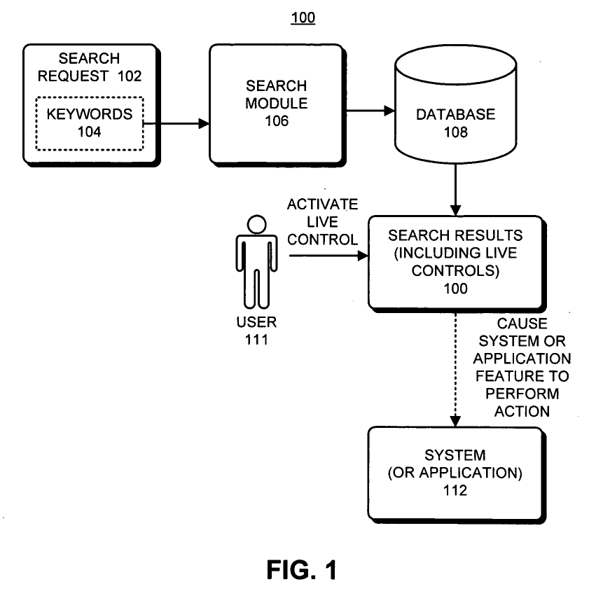

FIG. 1 illustrates a lookup system 100 that facilitates looking up live controls for features of a target system (or application) 112 in accordance with an embodiment of the present invention. Target system (or application) 112 can include any type of system or application. For example, target system (or application) 112 can be an operating system, a document editor, an email program, an image-editing application, etc.

Note that the term “application” as used in this specification and appended claims can refer to any system which presents a user interface to perform a task. It is not limited to tools for editing documents, and can, for example, include tools for system management, and tools for embedded/turnkey systems. (Hence, the Windows™ Desktop and the Macintosh™ Finder are “applications” in this sense.)

Lookup system 100 includes a search module 106 and a database 108. During operation, search module 106 receives keywords 104, which are associated with a feature of target system (or application) 112. For example, the keywords 104 can be part of a search request 102 for a feature of target system (or application) 112 received from a user. Alternatively, the keywords can be automatically generated by another system.

Search module 106 uses the keywords to perform a search through database 108. This search produces search results 110, which include live controls for features of the target system (or application) 112. This enables a user 111 to activate a live control to cause a corresponding feature of the target system (or application) 112. (The term “live control” as used in this specification and the appended claims refers to a user interface element that can be selected or activated to trigger performance of an associated program action.)

Hence, the present invention (which we refer to as a “feature browser”) provides a query mechanism that facilitates directly accessing controls for the feature, thereby eliminating the need to detour through the help system.

A number of different scenarios can cause a query to be generated for system or application features. (1) The query can be generated to perform a semantic search for a feature. (2) The query can be generated based upon observations of previous user actions. (3) The query can be based on keywords provided by a user. (Note that due to the popularity of the search engines for the web, the keyword search/hyperlink model of finding and accessing information is already very familiar to most users.)

In cases where the actual control can be practically presented along with the results, there is no need to even bring up the dialog or palette the control resides in. A live control is presented near the search box; the user can “just click on it.”

Note that in addition to the live control, a menu path to the feature can also be presented as a hyperlink. This provides both an immediate cue for where the feature resides in the application, and a single-click way to get to it. (The term “hyperlink” as used in this specification and appended claims refers to a representation of a link in a user interface, which a user can activate to cause a target location, web page, menu or screen to be presented to the user. The term “menu path” refers to a path, starting from a primary menu bar, through sub-menus and dialogs/or palettes, to get to a particular feature. The menu path notation is already commonly used in help system and manual documentation.)

Furthermore, if the user wants more information about how to use the feature, a help button can be provided that takes the user to the relevant help page with a single click.

In one embodiment of the present invention, the feature browser is an application palette that is readily accessible by a user, for example, the application palette may be always available. Typing in a keyword into the feature browser immediately returns a list of possible matches. Each match provides at least a menu path hyperlink to the feature, and, if possible, a live control that a user (or another program component) can activate. Even if a control isn't available, a single click on the hyperlink can cause the system to present the relevant dialog, palette, or action.

The database for the keyword search can be generated from existing help information. Most applications have menu/dialog/event ID's that could be used to invoke the menu path links, so the help information can be annotated with the menu path/Event ID's to provide the required database. Many applications also have an automation feature, which records user actions and plays them back, and some of the facilities for building the feature browser may be taken from such an automation feature.

To implement live controls appearing in the feature browser, a database of control types (checkbox, button, pop-up, slider, etc.), event IDs for these controls, and control actions can be built. Again, some of this is available in current implementations of automation systems. It is possible to add facilities to these frameworks to reproduce dialog controls independently in another context like the feature browser. Doing this reduces the amount of core application code needed to support the feature browser.

Note that the design of the feature browser allows live controls to be added as the system evolves. The first version of the system may have just a few, and provide mostly menu path hyperlinks. Subsequent version of the system can add more live controls to the feature browser as the internal frameworks grow to support it. (Note that a hyperlink is different than a live control because activating a hyperlink does not perform an associated program action, but instead causes the system to navigate to a target location, web page, menu, or screen where a live control may be located. In contrast, a live control can be activated to cause an associated program action to take place, without first having to navigate to another control.)

Lookup Process

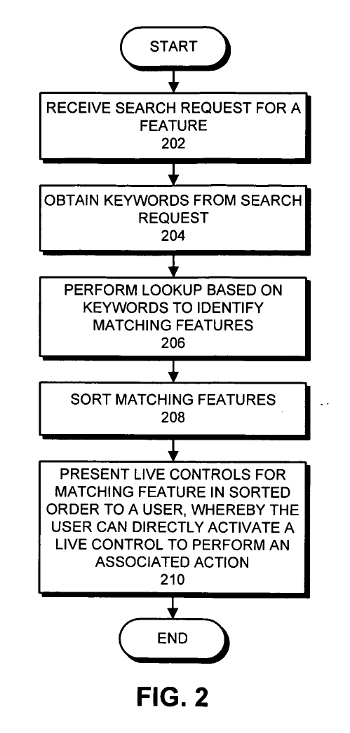

FIG. 2 presents a flow chart illustrating the lookup process in accordance with an embodiment of the present invention. This process can start when the system receives a “search request” from a user, which asks the system to lookup a feature based on one or more keywords (step 202). Next, the system obtains the one or more keywords from the search request (step 204). The system then performs a lookup based on the one or more keywords (step 206). This lookup operation returns a list of zero or more matching features. (Note that each feature in the database can be associated with a number of keywords to facilitate this lookup process.)

Next, the system sorts the matching features based on some type of relevancy score (step 208), and finally the system presents the matching features to the user (step 210). These features can be presented with live controls, which the user can directly activate to perform an associated action. If a live control is available for one of the matching features, the system provides it right below the search—active and ready to use. There is no need for the user to go off to another dialog or menu, the live control is present right there below the search. The user can “just click on it.”

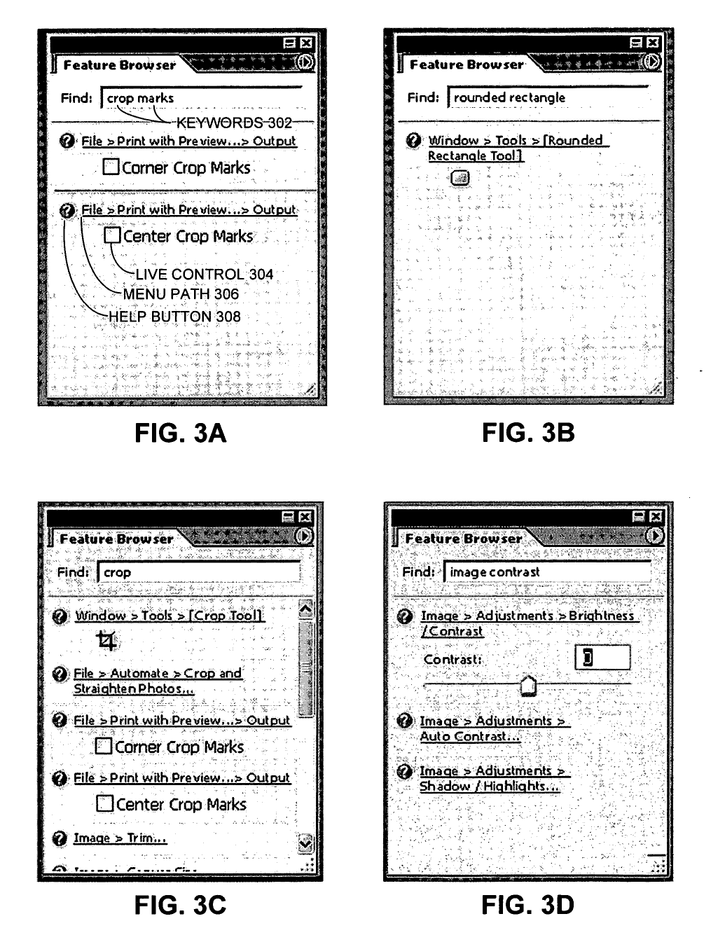

Some exemplary lists of matching features which can be produced by the feature browser are presented in FIGS. 3A-3D. The feature browsers illustrated in FIGS. 3A-3D accept keywords from a user. For example, the feature browser illustrated in FIG. 3A accepts the keywords “crop marks” 302 from a user. The feature browser then performs a search based on keywords 302 to return a list of matching features. In FIG. 3A, this list of matching features includes a “corner-crop-marks” feature and a “center-crop-marks” feature.

Note that unlike existing help systems, active controls for the matching features are presented in this list. This enables the user to directly activate the live control, without having to first click on a hyperlink to the live control, or otherwise navigate to the live control. For example, the feature browser illustrated in FIG. 3A displays a live control 304 for the center-crop-marks feature. This live control 304 is in the form of a checkbox which the user can directly activate to perform a center-crop-marks function.

In FIGS. 3A, 3C and 3D, note that the feature browser can return live controls for multiple results during a given query, wherein each result is associated with a different program action. This enables to user to activate a desired live control from a list of live controls presented to a user.

The lists illustrated in FIGS. 3A-3D also provide help information for the matching features. Clicking on the question mark next to a feature listing takes the user to the associated help item for the listing. For example, the feature browser illustrated in FIG. 3A displays a help button 304 (labeled with a question mark) along with the center-crop-marks feature, which links to help information associated with the center-crop-marks feature.

The lists also include hyperlinks to the matching features. Clicking on the hyperlink is the same as clicking on the menu item (or tool), and it performs the appropriate action or brings up the relevant dialog or palette. For example, the feature browser illustrated in FIG. 3A displays a menu path 306 along with the center-crop-marks feature which can act as a menu path hyperlink to the center-crop-marks feature.

In some cases the listed item may not be available, for example if a document isn't open or isn't in the right state. In this case the link (and/or control) are displayed in a disabled form. A tooltip or additional text could explain why the item isn't available.

If a single tool or control is related to the item, the tool or control is presented directly in the feature browser, ready to click and use. In other cases, (for example if there are multiple controls for the feature and the multiple controls are too large to fit in the list), the user has to click on the link first to get to the appropriate dialog.

Furthermore, presenting a live control for a feature can also involve presenting a preview of the result of an action associated with the live control. In this way the user can view the result of the action before deciding to perform the action.

Also note that the present invention is not limited to searching for features of a single system or application. In general, the present invention can be used to search for features of an application and an operating system, or multiple applications at the same time. For example, the operating system and a number of applications may be arranged hierarchically, and the feature browser can navigate through features of the application and the operating system in the hierarchy. This is advantageous because it may not be obvious to a user if a specific feature is provided by the operating system, an application or a related application.

Note that the feature browser is more an alternate navigation tool for moderate to experienced users than a learning aid for new users. It is a feature-based, as opposed to task-based, solution, such as recipes or traditional. Due to the popularity of search engines for the web, the paradigm of using a keyword search to get to information is familiar to anybody using computers these days. Moreover, since almost all features of a system or application are available via a menu as a starting point, by listing the “menu path” to the feature, the feature browser provides a concise specification of where the feature is located.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for providing access to features of a system or an application via a query, comprising:
obtaining the query;
identifying features of the system or the application which are associated with results of the query; and
presenting live controls for the associated features to a user, whereby the user can activate the live controls to trigger associated actions, thereby avoiding the need to first navigate to a live control.

2. The method of claim 1, wherein obtaining the query involves receiving a search request for a feature, wherein the search request includes the one or more key words.

3. The method of claim 1, wherein presenting live controls for associated features additionally involves presenting menu-path hyperlinks for the associated features to the user.

4. The method of claim 1, wherein presenting live controls for the associated features also involves providing access to help information for the associated features.

5. The method of claim 1, wherein if an associated feature is not presently available, the corresponding live control is presented to the user in a manner which indicates that the feature is disabled.

6. The method of claim 1, wherein presenting a live control for an associated feature involves presenting a preview of the result of an action associated with the live control.

7. The method of claim 1, wherein a live control for a feature is a user interface element, which can be activated to perform an associated action.

8. A computer-readable storage medium storing instructions that when executed by a computer cause the computer to perform a method for providing access to features of a system or an application via a query, the method comprising:
obtaining the query;
identifying features of the system or the application which are associated with results of the query; and
presenting live controls for the associated features to a user, whereby the user can activate the live controls to trigger associated actions, thereby avoiding the need to first navigate to a live control.

9. The computer-readable storage medium of claim 8, wherein obtaining the one or more keywords involves receiving a search request for a feature, wherein the search request includes the one or more key words.

10. The computer-readable storage medium of claim 8, wherein presenting live controls for associated features additionally involves presenting menu-path hyperlinks for associated features to the user.

11. The computer-readable storage medium of claim 8, wherein presenting live controls for the associated features also involves providing access to help information for the associated features.

12. The computer-readable storage medium of claim 8, wherein if an associated feature is not presently available, the corresponding live control is presented to the user in a manner which indicates that the feature is disabled.

13. The computer-readable storage medium of claim 8, wherein presenting a live control for an associated feature involves presenting a preview of the result of an action associated with the live control.

14. The computer-readable storage medium of claim 8, wherein a live control for a feature is a user interface element, which can be activated to perform an associated action.

15. A computer system that provides access to features of a system or an application via a query, comprising:
a processor;
a memory;
a receiving mechanism configured to receive the query;
a identification mechanism configured to identify features of the system or the application which are associated with results of the query; and
a presentation mechanism configured to present live controls for the associated features to a user, whereby the user can activate the live controls to trigger associated actions, thereby avoiding the need to first navigate to a live control.

16. The computer system of claim 15, wherein the receiving mechanism is configured to receive keywords as part of a search request for a feature, wherein the search request includes the one or more key words.

17. The computer system of claim 15, wherein while presenting live controls for associated features, the presentation mechanism is configured to present menu-path hyperlinks for the associated features to the user.

18. The computer system of claim 15, wherein while presenting live controls for the associated features, the presentation mechanism is configured to provide access to help information for the associated features.

19. The computer system of claim 15, wherein if an associated feature is not presently available, the presentation mechanism is configured to present the corresponding live control in a manner which indicates that the feature is disabled.

20. The computer system of claim 15, wherein while presenting a live control for an associated feature, the presentation mechanism is configured to present a preview of the result of an action associated with the live control.

21. The computer system of claim 15, wherein a live control for a feature is a user interface element, which can be activated to perform an associated action.
